(19) United States
(12) Patent Application Publication
(10) Pub. No.: US 2009/0058330 A1
(43) Pub. Date: Mar. 5, 2009

(54) DRIVING A MULTI-PHASED MOTOR

(75) Inventors: Brian Dean Boling, Lafayette, CO (US); Michael Ernest Dickeson, Westminster, CO (US)

Correspondence Address: HENSLEY KIM & HOLZER, LLC, 1660 LINCOLN STREET, SUITE 3000, DENVER, CO, 80264, US

(73) Assignee: SEAGATE TECHNOLOGY LLC, Scotts Valley, CA (US)

(21) Appl. No.: 11/847,494

(22) Filed: Aug. 30, 2007

(51) Int. Cl. H02P 25/10

(52) U.S. Cl. 318/244

(57) ABSTRACT

Motor control circuitry reduces the amount of driving voltage profile data stored in a profile datastore to completely rotate the phased motor. The stored driving voltage profile data defines driving voltages samples applied during a limited portion of the electrical period required to completely rotate the phased motor. For example, in one implementation, only one-sixth of the electrical period is defined and stored in a profile datastore. The driving voltage samples for another three-sixths of the electrical period are derived from this one-sixth profile (e.g., reversing, inverted, reversed and inverted), and the driving voltage samples for another two-sixths of the electrical period are based on saturated levels at the power supply voltage and a neutral voltage (e.g., ground). The described motor control circuitry can also provide improved torque at low power supply levels, particularly when saturated portions of the driving voltage profile exceed sixty degrees.

### SUMMARY

Some storage devices, such as magnetic and optical disc drives, have three-phased spindle motors that spin one or more magnetic or optical discs during operation. Such phased motors may be controlled by a motor control circuit assembled upon a printed circuit board (PCB). The motor control circuit described herein provides driving voltage waveform profiles based on assumptions of sinusoidal phase current and phase back electromotive force (BEMF) wave shapes. The new waveform profiles reduce digital storage requirements and increase developed torque under low supply voltage conditions over existing approaches.

Implementations described and claimed herein reduce the amount of driving voltage profile data stored in a profile datastore to completely rotate the phased motor. The stored driving voltage profile data defines driving voltages samples applied during a limited portion of the electrical period required to completely rotate the phased motor. For example, in one implementation, only one-sixth of the electrical period is defined and stored in a profile datastore. The driving voltage samples for another three-sixths of the electrical period are derived from this one-sixth profile (e.g., reversing, inverted, reversed and inverted), and the driving voltage samples for another two-sixths of the electrical period are based on saturated levels at the power supply voltage and a neutral voltage (e.g., ground). The described motor control circuitry can also provide improved torque at low power supply levels, particularly when one or more of the saturated portions of the driving voltage profile exceed sixty degrees each.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. It should also be understood that, although disc drive implementations are described here, the described technology may be applied to other systems.

### BRIEF DESCRIPTIONS OF THE DRAWINGS

FIG. 1 illustrates a plan view of an example disc drive.

FIG. 2 illustrates the example functional components of a disc drive.

FIG. 3 illustrates example motor control circuitry driving a phased motor.

FIG. 4 illustrates example driving voltage profiles for a three phased motor.

FIG. 5 illustrates example operations for driving a phased motor.

FIG. 6 illustrates an example eight element profile datastore in floating point format.

### DETAILED DESCRIPTIONS

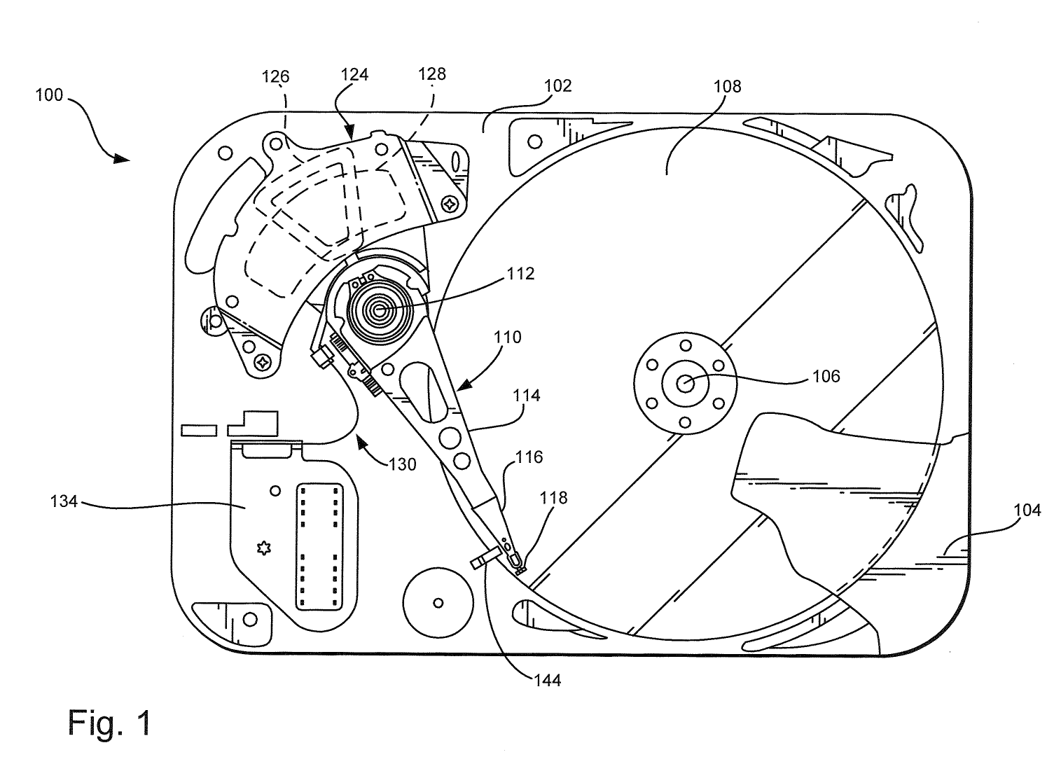

FIG. 1 illustrates a plan view of an example disc drive 100. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more storage medium discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108. The distance between the head 118 and the storage media surface during flight is referred to as the “fly height”.

During a seek operation, the track position of the head 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved away from portions of the disk 108 containing data when the drive motor is de-energized. The heads 118 are secured over portions of the disk not containing data through the use of an actuator latch arrangement and/or ramp assembly 144, which prevents inadvertent rotation of the actuator assembly 110 when the drive discs 108 are not spinning.

A flex assembly 130 provides the requisite electrical connection paths for the actuator assembly 110 while allowing pivotal movement of the actuator assembly 110 during operation. The flex assembly 130 includes a printed circuit board 134 to which a flex cable connected with the actuator assembly 100 and leading to the head 118 is connected. The flex cable may be routed along the actuator arms 114 and the flexures 116 to the heads 118. The printed circuit board 134 typically includes circuitry for controlling the write currents applied to the heads 118 during a write operation and a preamplifier for amplifying read signals generated by the heads 118 during a read operation. The flex assembly 130 terminates at a flex bracket for communication through the base deck 102 to a disc drive printed circuit board (not shown) mounted to the bottom side of the disc drive 100.

In an exemplary implementation, the spindle control circuitry in the disc drive 100 includes a profile datastore that stores driving voltage profile data defining a limited portion of a full driving voltage profile for rotating the spindle motor. The limited portion of the driving voltage profile is limited to one-sixth of the electrical period for completely rotating the spindle motor.

In one implementation, the spindle control circuitry in the disc drive 100 also includes a commutation logic circuitry coupled to the profile datastore and to winding terminals of the spindle motor. The commutation logic circuitry drives each winding terminal of the spindle motor to completely rotate the spindle motor, wherein at least four of six excitation states of the winding terminal provide driving voltages that are defined or derived from the limited portion of the driving voltage profile stored in the profile datastore.

In an alternative implementation, the commutation logic circuit is coupled to winding terminals of a spindle motor and drives each winding terminal of the spindle motor with a driving voltage defined by a driving voltage profile that includes for each winding terminal at least one excitation state of the winding terminal saturated at a power supply voltage and at least one excitation state of the winding terminal saturated at a neutral level.

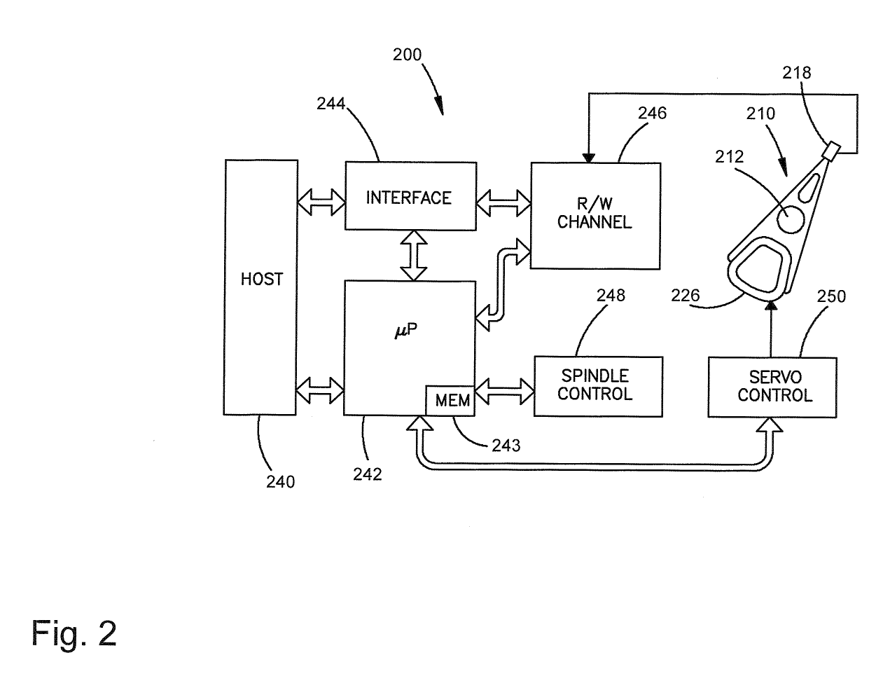

FIG. 2 illustrates the primary functional components of a disc drive incorporating one of the various implementations of the described technology and generally shows the main functional circuits that are resident on the disc drive printed circuit board and used to control the operation of the disc drive. The disc drive is operably connected to a host computer 240 in a conventional manner. Control communication paths are provided between the host computer 240 and a disc drive microprocessor 242, the microprocessor 242 generally providing top level communication and control for the disc drive in conjunction with programming for the microprocessor 242 stored in microprocessor memory (MEM) 243. The MEM 243 can include random access memory (RAM), read only memory (ROM) and other sources of resident memory for the microprocessor 242.

The discs are rotated at a constant high speed by a spindle motor control circuit 248, which typically electrically commutates the spindle motor through the use, typically, of back electromotive force (BEMF) sensing. During a seek operation, wherein an actuator 210 moves heads 218 between tracks on the storage media, the position of the heads 218 is controlled through the application of current to the coil 226 of a voice coil motor. A servo control circuit 250 provides such control. During a seek operation the microprocessor 242 receives information regarding the velocity of the head 218, and uses that information in conjunction with a velocity profile stored in memory 243 to communicate with the servo control circuit 250, which will apply a controlled amount of current to the voice coil motor coil 226, thereby causing the actuator assembly 210 to be pivoted.

Data is transferred between the host computer 240 or other device and the disc drive by way of an interface 244, which typically includes a buffer to facilitate high speed data transfer between the host computer 240 or other device and the disc drive. Data to be written to the disc drive is thus passed from the host computer 240 to the interface 244 and then to a read/write channel 246, which encodes and serializes the data and provides the requisite write current signals to the heads 218. To retrieve data that has been previously stored in the data storage device, read signals are generated by the heads 218 and provided to the read/write channel 246, which performs decoding and error detection and correction operations and outputs the retrieved data to the interface 244 for subsequent transfer to the host computer 240 or other device.

In an exemplary implementation, the spindle motor control circuit 248 in the disc drive 200 includes a profile datastore that stores driving voltage profile data defining a limited portion of a full driving voltage profile for rotating the spindle motor. The limited portion of the driving voltage profile is limited to one-sixth of the electrical period for completely rotating the spindle motor.

In one implementation, the spindle motor control circuit 248 in the disc drive 200 also includes a commutation logic circuitry coupled to the profile datastore and to winding terminals of the spindle motor. The commutation logic circuitry drives each winding terminal of the spindle motor to completely rotate the spindle motor, wherein at least four of six excitation states of the winding terminal provide driving voltages are defined or derived from the limited portion of the driving voltage profile stored in the profile datastore.

In an alternative implementation, the commutation logic circuit is coupled to winding terminals of a spindle motor and drives each winding terminal of the spindle motor with a driving voltage defined by a driving voltage profile that includes for each winding terminal at least one excitation state of the winding terminal saturated at a power supply voltage and at least one excitation state of the winding terminal saturated at a neutral level.

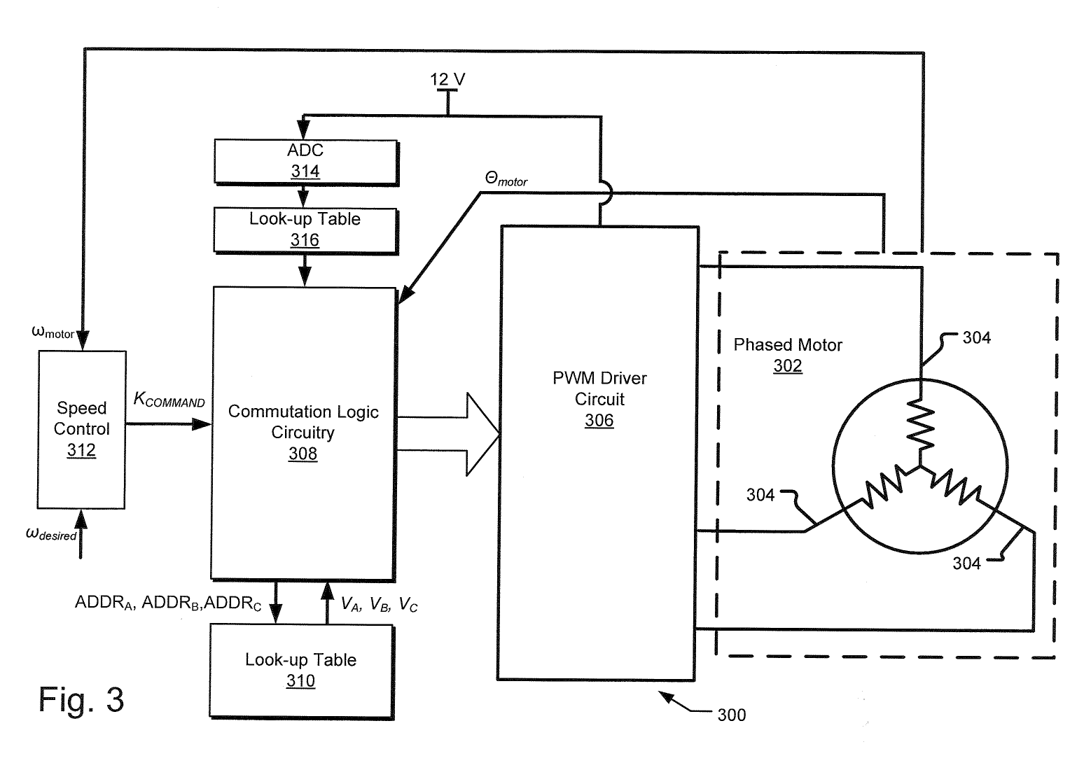

FIG. 3 illustrates example motor control circuitry 300 driving a phased motor 302, such as a spindle motor of a data storage drive, although other phased motors may also employ the described technology. The phased motor 302 includes winding terminals 304, each of which are generally supplied with varying terminal voltages to effect complete rotation of the phased motor 302. A pulse-width-modulated (PWM) driver circuit 306 receives scaled driving voltage samples from commutation logic circuitry 308 and PWM-converts the scaled driving voltage samples. The PWM driver circuit 306 then outputs the resulting PWM signals to the terminals 304 to rotate the phased motor 302.

A speed control module 312 receives an angular velocity signal ωₘₒₜₒᵣ, which is monitored from the phased motor 302, and a target angular velocity signal ω_{desired}, which is provided by firmware or is specified in memory. The speed control module 312 evaluates ωₘₒₜₒᵣ and ω_{desired} and generates a scaling factor K_{COMMAND}, which it sends to the commutation logic circuitry 308 to influence the driving voltages provided to the terminals 304 of the phased motor 308.

The commutation logic circuitry 308 receives an angle signal θₘₒₜₒᵣ, which is monitored from the phased motor 302, and uses the angle signal θₘₒₜₒᵣ to form an address into a look-up table 310. The look-up table 310 stores driving voltage data for a limited portion of the full driving voltage profile. In one implementation, the look-up table 310 stores driving voltage data for one-sixth of an electrical period for completely rotating the phased motor 302 a full three hundred and sixty degrees. The one-sixth of the electrical period corresponds to one of six excitation states of the phased motor 302. The driving voltage data for three other excitation states of the phased motor 302 are scaled and otherwise derived from (i.e., based on but further altered from) the stored driving voltage data: (a) in one of the other excitation states, the driving voltage samples are scaled and temporally reversed from that of the stored driving voltage data; (b) in another of the other excitation states, the driving voltage samples are scaled and inverted from that of the stored driving voltage data; and (c) in yet another of the other excitation states, the driving voltage samples are scaled, inverted, and temporally reversed from that of the stored driving voltage data. (The commutation logic circuitry 308 scales the driving voltage data for these excitation states by the scaling factor K_{COMMAND} received from the speed control module 312 and possibly a power supply scaling factor.)

In two other excitation states, the driving voltage is saturated and is independent of the stored driving voltage samples: (a) in one of the saturated excitation states, the driving voltage is saturated at a maximum voltage (e.g., the power supply voltage or some other maximum voltage threshold); and (b) in one of the saturated excitation states, the driving voltage is saturated at a minimum voltage (e.g., a neutral voltage, such as ground, or some other minimum voltage threshold).

As described, the look-up table 310 stores the driving voltage samples for a limited portion of the electrical period for completely rotating the phased motor 302. In one implementation, the driving voltage samples of the limited portion pertains to an excitation state that occupies one-sixth or sixty degrees of the three hundred and sixty degree electrical period and is approximated by the following equation, where P_{ideal} represents discrete values of an ideal representation of the full driving voltage profile for a given phase, with the angular sampling increment selected to reproduce a desired level of cosine wave fidelity:

P_{ideal}=cos(θₛₐₘₚₗₑ−60°), 0°≦θₛₐₘₚₗₑ≦60° Equation (1)

In one implementation, given a three phase motor, such as a motor used in hard disc drive spindle motor applications, the terminal voltages for phases A, B, and C, can be computed for individual excitation states of the phased motor, where sinusoidal phase currents and phase back electromotive force (BEMF) voltages are assumed. In the description below, V_{XT} represents a terminal voltage of phase X, V_{XB} represents a BEMF voltage of phase X, Z_{X} represents impedance of phase X, Kᵥ represents a phase-centertap voltage constant, I_{X} represents the phase current of phase X, V_{M} represents the maximum sinusoidal phase voltage (e.g., the circuit power supply voltage), and I_{M} represents the peak phase current amplitude. Given the following representations of BEMF voltages and phase currents, the terminal voltages may be computed for multiple phases of the electrical period required to completely rotate the phased motor:

V_{AB}=Kᵥω sin(θ)

V_{BB}=Kᵥω sin(θ−120°)

V_{CB}=Kᵥω sin(θ−240°)

I_{A}=I_{M} sin(θ)

I_{B}=I_{M} sin(θ−120°)

I_{B}=I_{M} sin(θ−240°)

0-60°

V_{AT}=\sqrt{3}(Kᵥω+I_{M}Z_{A})(cos(θ−60°))

V_{BT}=0 (saturated at ground)

V_{CT}=\sqrt{3}(Kᵥω+I_{M}Z_{C})cos θ

60°-120°

V_{AT}=V_{M} (saturated at maximum voltage)

V_{BT}=V_{M}−\sqrt{3}(Kᵥω+I_{M}Z_{B})(cos(θ−60°))

V_{CT}=V_{M}−\sqrt{3}(Kᵥω+I_{M}Z_{C})(cos(θ+60°))

120°-180°

V_{AT}=−\sqrt{3}(Kᵥω+I_{M}Z_{A})(cos(θ+60°))

V_{BT}=−\sqrt{3}(Kᵥω+I_{M}Z_{B})cos θ

V_{CT}=0 (saturated at ground)

180°-240°

V_{AT}=V_{M}+\sqrt{3}(Kᵥω+I_{M}Z_{A})(cos(θ−60°))

V_{BT}=V_{M} (saturated at maximum voltage)

V_{CT}=V_{M}+\sqrt{3}(Kᵥω+I_{M}Z_{C})cos θ

240°-300°

V_{AT}=0 (saturated at ground)

V_{BT}=−\sqrt{3}(Kᵥω+I_{M}Z_{B})(cos(θ−60°))

V_{CT}=\sqrt{3}(Kᵥω+I_{M}Z_{C})(cos(θ+60°))

300°-360°

V_{AT}=V_{M}−\sqrt{3}(Kᵥω+I_{M}Z_{A})(cos(θ−60°))

V_{BT}=V_{M}−\sqrt{3}(Kᵥω+I_{M}Z_{B})cos θ

V_{CT}=V_{M} (saturated at maximum voltage)

In one implementation, K is defined as K=\sqrt{3}(Kᵥω+I_{M}Z_{B}), and V_{M} is normalized. In this manner, K=1 corresponds to the zero margin case, where BEMF voltages and resistance drops precisely match Vₘ voltage.

In application, normalized driving waveform samples are stored as digital quantities with an assumed binary point. For N-bit quantization, stored sample values are calculated as specified in Equation (2):

Pₛₐₘₚₗₑ=round(2^{N} cos(θₛₐₘₚₗₑ−60°)) Equation (2)

Equation 3 represents effective sample values considering the assumed binary point. In this manner, the effective sample values are fractional numbers in the range of 0.5 to 1.0, as is appropriate for Equation 1.

P_{effective}−Pₛₐₘₚₗₑ/2^{N} Equation (3)

A look-up table of stored sample values is indexed at a rate based on phased motor rotational speed and chosen cosine wave sampling interval. Each sample value is multiplied by the digital amplitude scaling factor K_{COMMAND}, received from a speed control module, to generate a PWM command that is provided to the PWM driver.

In a voltage mode PWM system, such as an implementation that has been described herein, effective terminal voltage is directly related to supply voltage. Therefore, to compensate for supply variations, supply voltage is sampled at the PWM rate and the result of this measurement is used to modify the calculated PWM command.

Supply voltage compensation is provided by the combination of analog-digital converter (ADC) 314 and look-up table 316. In one implementation, supply voltage compensation maps all voltage in a specified range to a maximum voltage, by successively increasing the calculated PWM duty cycle for successively lower supply voltages within the specified range. For example, desktop disc drives are specified to operate over a supply voltage range of 10.8V-13.2V (e.g., V_{supply,nom}±V_{,deviation,max}=12V±12V). Supply voltage compensation maps input voltages within this range to 13.2V (V_{supply,max}).

The digital output from the ADC 314 is effectively normalized by a voltage supply scaling factor K_{S}, which is provided by the look-up table 316. At low power supply voltage levels, the compensated supply voltage and the saturation of the driving voltages in an excitation state of each phase combine to provide improved torque over previous approaches. The improved torque translates to improved spin-up performance at minimum supply voltage and cold temperature (where phased motor bearing drag can be high).

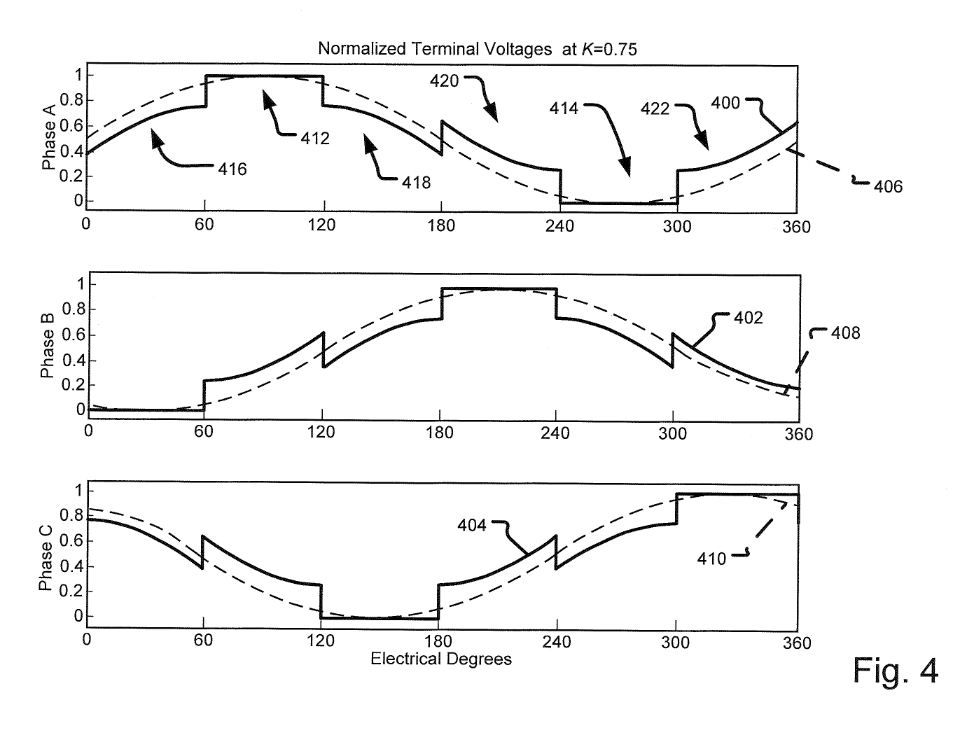

FIG. 4 illustrates example driving voltage profiles 400, 402, and 404 for a three phased motor with the K term described in section 0029 set to 0.75. The normalized terminal voltages (i.e., representing the duty cycle) for each phase are plotted relative to the degrees in the electrical period for completely rotating the phased motor. The three driving profiles 400, 402, and 404 include six excitation states: (1) 0°-60°; (2) 60°-120°; (3) 120°-180°; (4) 180°-240°; (5) 240°-300°; and (6) 300°-360°. The dashed lines in FIG. 4 represent normalized phased BEMF voltage and illustrate an example relationship between BEMF and driving voltage waveforms.

In the excitation state (1) of the Phase A graph, a limited portion 416 of the complete driving voltage profile is defined by driving voltage samples stored in a profile datastore (e.g., a look-up table, such as shown as look-up table 310 in FIG. 3). The driving voltage sample span is limited to sixty degrees, thereby reducing the digital data storage requirements of the profile datastore over previous approaches.

In excitation state (2) of the Phase A graph, a limited portion 412 of the full driving voltage profile is defined as saturated at the power supply voltage.

In excitation state (3) of the Phase A graph, a limited portion 418 of the complete driving voltage profile is derived from the driving voltage samples stored in the profile datastore for excitation state (1), wherein the limited portion 418 is temporally reversed from the limited portion 416. In one implementation, the driving voltage samples of the limited portion 418 are derived (i.e., reversed) from the driving voltage samples of the limited portion 416 using a state machine in the communication logic circuitry.

In excitation state (4) of the Phase A graph, a limited portion 420 of the complete driving voltage profile is derived from the driving voltage samples stored in the profile datastore for excitation state (1), wherein the limited portion 420 is inverted from the limited portion 416. In one implementation, the driving voltage samples of the limited portion 420 are derived (i.e., inverted) from the driving voltage samples of the limited portion 416 using a state machine in the communication logic circuitry.

In excitation state (5) of the Phase A graph, a limited portion 414 of the full driving voltage profile is defined as saturated at a neutral voltage (e.g., ground).

In excitation state (6) of the Phase A graph, a limited portion 422 of the complete driving voltage profile is derived from the driving voltage samples stored in the profile datastore for excitation state (1), wherein the limited portion 422 is inverted and temporally reversed from the limited portion 416. In one implementation, the driving voltage samples of the limited portion 422 are derived (i.e., inverted and reversed) from the driving voltage samples of the limited portion 416 using a state machine in the communication logic circuitry.

The commutation logic circuitry generates driving voltage samples for the other three phases concurrently and in a similar fashion, offset by the appropriate phase shifts. It should be understood that the variations of the multiple excitation states may be achieved through a variety of logical operations and are not limited to the operations (e.g., inverting, reversing) described with regard to FIG. 4.

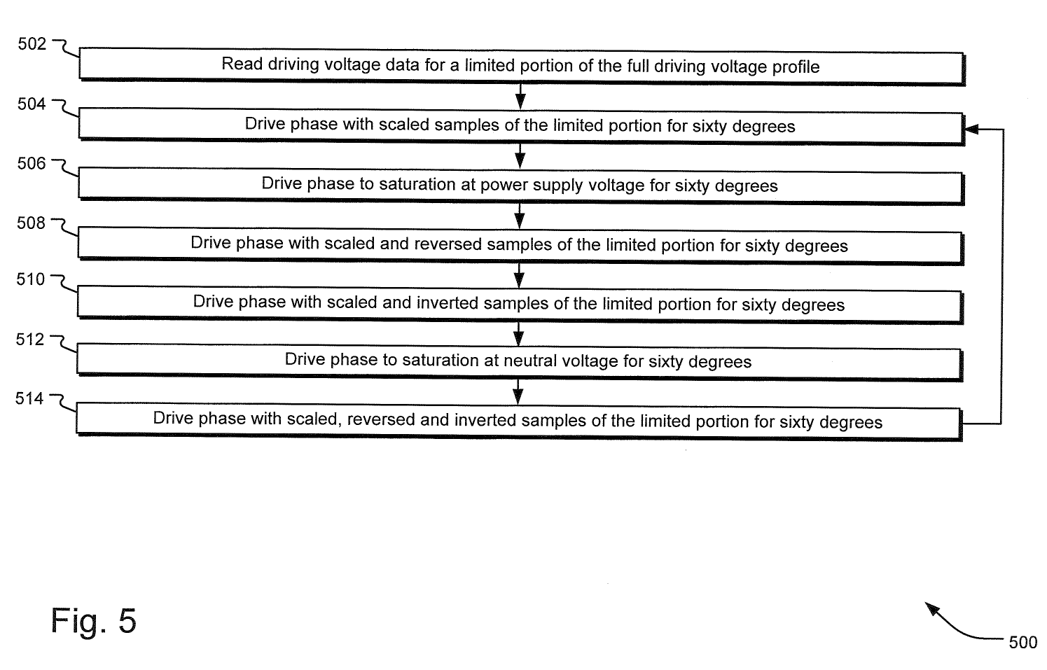

FIG. 5 illustrates example operations 500 for driving a phased motor. It should be understood that the operations 500 are performed concurrently for the multiple phases of the phased motor, offset by the appropriate phase shifts. The operations 500 define a driving voltage profile for an example phase (e.g., phase A). A reading operation 502 reads driving voltage samples from a profile datastore for a limited portion of the full driving voltage profile of a given phase (e.g., phase A).

Based on the driving voltage samples read from the profile datastore, a driving operation 504 drives the terminal in a first excitation state with scaled samples of the limited portion for sixty degrees of the electrical period for completely rotating the phased motor. The samples are scaled by a scaling factor or command (K_{COMMAND}) received from a speed control module and by a voltage supply scaling factor received from a look-up table.

Independent of the driving voltage samples read from the profile datastore, a driving operation 506 drives the terminal in a second excitation state to saturation at the power supply voltage for sixty degrees of the electrical period for completely rotating the phased motor.

Based on the driving voltage samples read from the profile datastore, a driving operation 508 drives the terminal in a third excitation state with scaled samples derived from the limited portion stored in the profile datastore for sixty degrees of the electrical period for completely rotating the phased motor. In this excitation state, the scaled samples are temporally reversed from their order in the profile datastore. The samples are scaled by a scaling factor or command received from a speed control module and by a voltage supply scaling factor received from a look-up table.

Based on the driving voltage samples read from the profile datastore, a driving operation 510 drives the terminal in a fourth excitation state with scaled samples derived from the limited portion stored in the profile datastore for sixty degrees of the electrical period for completely rotating the phased motor. In this excitation state, the scaled samples are inverted (e.g., Vₘ−V_{Sample}) from their values in the profile datastore. The samples are scaled by a scaling factor or command received from a speed control module and by a voltage supply scaling factor received from a look-up table.

Independent of the driving voltage samples read from the profile datastore, a driving operation 512 drives the terminal in a fifth excitation state to saturation at a neutral voltage (e.g., ground) for sixty degrees of the electrical period for completely rotating the phased motor.

Based on the driving voltage samples read from the profile datastore, a driving operation 514 drives the terminal in a sixth excitation state with scaled samples derived from the limited portion stored in the profile datastore for sixty degrees of the electrical period for completely rotating the phased motor. In this excitation state, the scaled samples are inverted and temporally reversed from their order in the profile datastore. The samples are scaled by a scaling factor or command received from a speed control module and by a voltage supply scaling factor received from a look-up table.

Processing returns to the driving operation 504 to repeat the driving operations for each electrical period of the phased motor.

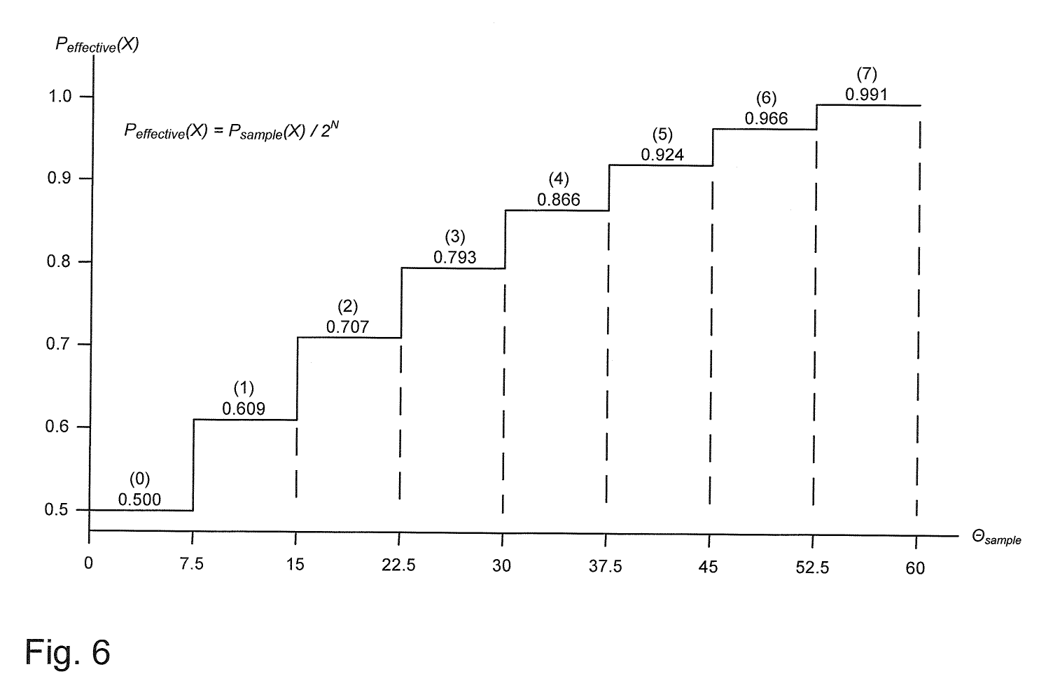

FIG. 6 illustrates an example eight element (0-7) profile datastore in floating point format. Each sixty degree portion of the electrical rotation may be divided up into multiple samples. In the illustrated example, each sixty degree portion is divided up into 8 samples−60°/8 samples=7.5°/sample (0°-7.5°, 7.5°-15°, 15°-22.5°, 30°-37.5°, 37.5°-45°, 45°-52.5°, 52.5°-60°), although other subdivisions may be employed. Various implementations may employ floating point arithmetic or integer arithmetic, depending on the available system resources. The values in the parentheses (e.g., (0), (1), . . . (7)) represent the sample index. The values under the parentheses (e.g., 0.5, 0.609, . . . 0.991) represent P_{effective} values, per Equation (3).

The scaling factor

$$\frac{{V}_{supply , max}}{{V}_{supply}}$$

is generated based on output from the ADC 314 and the lookup table 316 of FIG. 3. The scaling factor maps power supply voltages in the range V_{supply,nom}±V_{deviation,max} to the maximum supply voltage given by V_{supply,max}=V_{supply,nom}+V_{deviation,max}.

In one implementation, for each sample in each sixty degree period, three output voltages are generated, one for each winding terminal of a multi-phased motor. For two of the windings/terminals, the output voltage is computed from a profile data value read or derived from the profile data in a look-up table (e.g., look-up table 310). The output voltage for the third winding terminal is saturated at the power supply voltage or at ground. Furthermore, it should be understood that, depending on the scaling factor

$$\frac{{V}_{supply , max}}{{V}_{supply}}$$

and the value of K_{COMMAND}, the computed output voltage for any winding in given sample may be scaled to a saturation level (e.g., the power supply level or ground). For the 0°-60° electrical angle interval, example duty cycle calculations for select samples are given below, where K_{COMMAND,max} for an n-bit command register equals (2^{N}−1):

$$\underline{0 \text{-} 60 ° ELECTRICAL PERIOD WITH REFERENCE TO} \\ \underline{FIGs . 4 AND 6} \\ \begin{matrix}{D}_{A} = {K}_{COMMAND} ( \frac{{P}_{effective} ( 0 ) * {V}_{supply , max}}{{K}_{COMMAND , max} * {V}_{supply}} ) \\ {D}_{B} = 0 \\ {D}_{C} = {K}_{COMMAND} ( \frac{{P}_{effective} ( 7 ) * {V}_{supply , max}}{{K}_{COMMAND , max} * {V}_{supply}} )\end{matrix} \} 0 ° \text{-} 7.5 ° \\ \begin{matrix}{D}_{A} = {K}_{COMMAND} ( \frac{{P}_{effective} ( 1 ) * {V}_{supply , max}}{{K}_{COMMAND , max} * {V}_{supply}} ) \\ {D}_{B} = 0 \\ {D}_{C} = {K}_{COMMAND} ( \frac{{P}_{effective} ( 6 ) * {V}_{supply , max}}{{K}_{COMMAND , max} * {V}_{supply}} )\end{matrix} \} 7.5 ° \text{-} 15 ° \\ 15 \text{-} 52.5 ° \text{-} not shown for brevity \\ \begin{matrix}{D}_{A} = {K}_{COMMAND} ( \frac{{P}_{effective} ( 7 ) * {V}_{supply , max}}{{K}_{COMMAND , max} * {V}_{supply}} ) \\ {D}_{B} = 0 \\ {D}_{C} = {K}_{COMMAND} ( \frac{{P}_{effective} ( 0 ) * {V}_{supply , max}}{{K}_{COMMAND , max} * {V}_{supply}} )\end{matrix} \} 52.5 ° \text{-} 60 °$$

As such, in the sixty degree electrical interval (0°-60°), the phase A duty cycle is obtained by stepping through the profile data (P_{effective}) in the lookup table in a forward order and implementing the appropriate equation above to generate the normalized terminal voltage. The phase B duty cycle is saturated (e.g., held constant) at a normalized terminal voltage of 0. The phase C duty cycle is obtained from stepping through the profile data in the lookup table in a reverse order and implementing the appropriate equation above to generate the normalized terminal voltage.

For the 60°-120° electrical angle interval, example duty cycle calculations for select samples are given below:

$$\underline{60 \text{-} 120 ° ELECTRICAL PERIOD WITH REFERENCE TO} \\ \underline{FIGs . 4 AND 6} \\ \begin{matrix}{D}_{A} = 1 \\ {D}_{B} = 1 - {K}_{COMMAND} ( \frac{{P}_{effective} ( 7 ) * {V}_{supply , max}}{{K}_{COMMAND , max} * {V}_{supply}} ) \\ {D}_{C} = 1 - {K}_{COMMAND} ( \frac{{P}_{effective} ( 0 ) * {V}_{supply , max}}{{K}_{COMMAND , max} * {V}_{supply}} )\end{matrix} \} 60 ° \text{-} 67.5 ° \\ \begin{matrix}{D}_{A} = 1 \\ {D}_{B} = 1 - {K}_{COMMAND} ( \frac{{P}_{effective} ( 6 ) * {V}_{supply , max}}{{K}_{COMMAND , max} * {V}_{supply}} ) \\ {D}_{C} = 1 - {K}_{COMMAND} ( \frac{{P}_{effective} ( 1 ) * {V}_{supply , max}}{{K}_{COMMAND , max} * {V}_{supply}} )\end{matrix} \} 67.5 ° \text{-} 75 ° \\ 75 \text{-} 112.5 ° \text{-} not shown for brevity \\ \begin{matrix}{D}_{A} = 1 \\ {D}_{B} = 1 - {K}_{COMMAND} ( \frac{{P}_{effective} ( 0 ) * {V}_{supply , max}}{{K}_{COMMAND , max} * {V}_{supply}} ) \\ {D}_{C} = 1 - {K}_{COMMAND} ( \frac{{P}_{effective} ( 7 ) * {V}_{supply , max}}{{K}_{COMMAND , max} * {V}_{supply}} )\end{matrix} \} 112.5 ° \text{-} 120 °$$

As such, in the sixty degree electrical interval (60°-120°), the phase A duty cycle is saturated (e.g., held constant) at a normalized terminal voltage of 1. The phase B duty cycle is obtained by stepping through the profile data (P_{effective}) in the lookup table in a reverse order and implementing the appropriate equation above to generate the normalized terminal voltage. The phase C duty cycle is obtained from stepping through the profile data in the lookup table in a forward order and implementing the appropriate equation above to generate the normalized terminal voltage. For the phase B and C duty cycles, the equations above include a subtraction from one to model the profiles of FIG. 4.

Ensuing sixty degree electrical periods follow a similar trend to model the representation of FIG. 4. For example, as shown, the normalized output voltage for winding terminal A tracks the following pattern in accordance with the example equations above:

0°-60° Follows profile from look-up table

60°-120° Saturated at 1 (e.g., power supply level)

120°-180° Follows profile from look-up table in reverse

180°-240° Follows an inverted profile from look-up table

240°-300° Saturated at 0 (e.g., neutral voltage level or ground)

300°-360° Follows an inverted profile from look-up table in reverse

For example, as shown, the normalized output voltage for winding terminal B tracks the following pattern in accordance with the example equations above:

0°-60° Saturated at 0 (e.g., neutral voltage level or ground)

60°-120° Follows an inverted profile from look-up table in reverse

120°-180° Follows profile from look-up table

180°-240° Saturated at 1 (e.g., power supply level)

240°-300° Follows profile from look-up table in reverse

300°-360° Follows an inverted profile from look-up table

For example, as shown, the normalized output voltage for winding terminal C tracks the following pattern in accordance with the example equations above:

0°-60° Follows profile from look-up table in reverse

60°-120° Follows an inverted profile from look-up table

120°-180° Saturated at 0 (e.g., neutral voltage level or ground)

180°-240° Follows an inverted profile from look-up table in reverse

240°-300° Follows profile from look-up table

300°-360° Saturated at 1 (e.g., power supply level)

Phase current, which drives the windings of an example multi-phased motor, is defined by phase impedance, applied phase-centertap voltage, and phase-centertap back electromotive force (BEMF) voltage, although it should be understood that some applicable multi-phased motors may not include a centertap terminal. Note that the

$$\frac{{V}_{supply , max}}{{V}_{supply}}$$

scaling factor can contribute to a calculated duty cycle greater than one or less than 0. In practice, this results in saturation at the supply rail or ground, respectively, in association with samples where the electrical period is not strictly defined to be saturated (e.g., period 300°-360° for phase C is strictly defined to be saturated). Accordingly, in combination with the sixty degree period of saturation, the scaled saturation can result in a non-sinusoidal phase current and in saturation for greater than sixty successive electrical degrees. Torque developed from such non-sinusoidal currents can exceed the torque that is achievable with sinusoidal currents.

Embodiments of the described technology have been discussed herein with reference to a magnetic disc drive. One skilled in the art will recognize that the described technology may also be applied to any data storage device, such as an optical disc drive, a magneto-optical disc drive, or a compact disc drive, having phased motor control. Further, one skilled in the art will understand that various implementations of the described technology are equally applicable to any type of electrical or electronic device capable of controlling a phased motor. For example, devices that may implement embodiments of the present invention include but are not limited to notebook computers, handheld devices such as Personal Digital Assistants (PDAs), cell phones, office equipment such as copiers and fax machines, woodworking and metalworking systems, transit vehicles, automobiles, other transportation systems, etc.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts described above. Rather, the specific features and acts described above are disclosed as example forms of implementing the claimed subject matter.

What is claimed is:

1. Motor control circuitry comprising:
a commutation logic circuit adapted to couple to winding terminals of a phased motor, wherein the communication logic circuit drives each winding terminal of the phased motor with a driving voltage, the driving voltage for each winding terminal including at least one excitation state of the winding terminal saturated at a power supply voltage and at least one excitation state of the winding terminal saturated at a neutral level.

2. The motor control circuitry of claim 1 further comprising:
a profile datastore coupled to the commutation logic circuit and storing a limited portion of a driving voltage profile for each winding terminal, the limited portion of the driving voltage profile being limited to one-sixth of an electrical period for completely rotating the phased motor.

3. The motor control circuitry of claim 1 wherein the at least one excitation state of the winding terminal saturated at the power supply voltage occupies at least sixty degrees of a three hundred and sixty degree rotation of the phased motor.

4. The motor control circuitry of claim 1 wherein the at least one excitation state of the winding terminal saturated at the neutral voltage occupies at least sixty degrees of a three hundred and sixty degree rotation of the phased motor.

5. The motor control circuitry of claim 1 wherein the at least one excitation state of the winding terminal saturated at the power supply voltage and the at least one excitation state of the winding terminal saturated at the neutral voltage each occupy greater than sixty degrees of a three hundred and sixty degree rotation of the phased motor.

6. The motor control circuitry of claim 1 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor.

7. The motor control circuitry of claim 1 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor, and at least one other excitation state of the winding terminal that follows a temporal reversal of the varying driving voltage samples.

8. The motor control circuitry of claim 1 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor, and at least one other excitation state of the winding terminal that follows an inversion of the varying driving voltage samples.

9. The motor control circuitry of claim 1 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor, and at least one other excitation state of the winding terminal that follows an inverted temporal reversal of the varying driving voltage samples.

10. A method comprising:
driving each winding terminal of a phased motor with a driving voltage that includes at least one excitation state of the winding terminal saturated at a power supply voltage and at least one excitation state of the winding terminal saturated at a neutral level.

11. The method of claim 10 further comprising:
storing a limited portion of a driving voltage profile for a winding terminal in a profile data store, the limited portion being limited to one-sixth of an electrical period for completely rotating the phased motor.

12. The method of claim 11 wherein the limited portion defines an excitation state of the winding terminal having a varying driving voltage.

13. The method of claim 10 wherein the at least one excitation state of the winding terminal saturated at a power supply voltage occupies at least sixty degrees of a three hundred and sixty degree rotation of the phased motor.

14. The method of claim 10 wherein the at least one excitation state of the winding terminal saturated at a neutral voltage occupies at least sixty degrees of a three hundred and sixty degree rotation of the phased motor.

15. The method of claim 10 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor, and at least one other excitation state of the winding terminal that follows a temporal reversal of the varying driving voltage samples.

16. The method of claim 10 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor, and at least one other excitation state of the winding terminal that follows an inversion of the varying driving voltage samples.

17. The method of claim 10 wherein the driving voltage further includes at least one excitation state of the winding terminal that follows varying driving voltage samples from a limited portion of a driving voltage profile, the limited portion occupying sixty degrees of a three hundred and sixty degree rotation of the phased motor, and at least one other excitation state of the winding terminal that follows an inverted temporal reversal of the varying driving voltage samples.

18. Motor control circuitry comprising:
a profile datastore that stores driving voltage samples defining a limited portion of a driving voltage profile for rotating a phased motor, the limited portion of the driving voltage profile being limited to one-sixth of the electrical period for completely rotating the phased motor;
commutation logic circuitry coupled to the profile datastore and adapted to couple to winding terminals of a phased motor, the commutation logic circuitry driving each winding terminal of the phased motor to completely rotate the phased motor, wherein at least four of six excitation states of the winding terminal provide driving voltages derived from the limited portion of the driving voltage profile stored in the profile datastore.

19. The motor control circuitry of claim 18 wherein at least one excitation state of the winding terminal is saturated at a power supply voltage and occupies at least sixty degrees of a three hundred and sixty degree rotation of the phased motor.

20. The motor control circuitry of claim 18 wherein at least one excitation state of the winding terminal is saturated at a neutral voltage and occupies at least sixty degrees of a three hundred and sixty degree rotation of the phased motor.
